(19) United States
(12) Patent Application Publication
(10) Pub. No.: US 2011/0260925 A1
(43) Pub. Date: Oct. 27, 2011

(54) MULTIBAND INTERNAL PATCH ANTENNA FOR MOBILE TERMINALS

(76) Inventor: Laurian Petru Chirila, Irvine, CA (US)

(21) Appl. No.: 12/766,008

(22) Filed: Apr. 23, 2010

(51) Int. Cl. H01Q 5/00; H01Q 9/04

(52) U.S. Cl. 343/700 MS

(57) ABSTRACT

A multi-band patch antenna configured for at least one of transmission or reception of electromagnetic waves in two or more frequency bands with respect to a surrounding environment, the antenna comprising: a conductive antenna element isolated from an electrical ground element of the antenna and configured for operating as a radiating surface for the electromagnetic waves with respect to the surrounding environment, the antenna element having a pair of slots dividing the antenna element into a first parasitic element, a second parasitic element, and a third element such that a first slot of the pair of slots electrically isolates the first parasitic element from the third element and a second slot of the pair of slots electrically isolates the second parasitic element from the third element; the ground element having at least one ground slot; a substrate having a selected dielectric constant and being positioned between the antenna element and the ground element, such that the antenna element is attached to a first surface of the substrate and the ground element is attached to a second surface of the substrate opposite the first surface; a feed point location of the antenna element positioned on the third element, such that only the third element of the antenna element is configured to be coupled to a signal conductor of a transmission line, such that the transmission line is configured to conduct current flow for at least one of towards the antenna element for transmission of the electromagnetic waves from the antenna element or away from the antenna element as a result of reception of the electromagnetic waves by the antenna element; and a feed point location of the ground element configured to be coupled to a ground conductor of the transmission line.

The present invention relates to antennas and their construction.

### BACKGROUND

Portable devices having wireless communications capabilities are currently available in several different forms, including mobile telephones, personal digital assistants and hand held scanners. The demand for wireless connectivity from portable devices is rapidly expanding. As a result, the demand for high performance, low cost, and cosmetically appealing antenna systems for such devices is also increasing.

One type of antenna commonly used in portable wireless devices are patch antennas. However a current disadvantage with some patch antennas is the need to have different physical antennas for different frequency bands, thus necessitating increased costs for various wireless device versioning that need differing frequency band operation configurations for the same or different countries.

It is recognised that antenna design parameters of patch size, patch shape, slot size, slot shape, slot location and antenna proximity to other structures (such as a display, a cable, a battery pack, etc.) affect the tunability of the antenna. Therefore, it may become necessary to redesign the antenna to achieve a similar performance with different single frequencies and/or different types of devices.

### SUMMARY

There is a need for a multi-band patch antenna that overcomes or otherwise mitigates at least one of the above discussed disadvantages.

It is recognised that antenna design parameters of patch size, patch shape, slot size, slot shape, slot location and antenna proximity to other structures (such as a display, a cable, a battery pack, etc.) affect the tunability of the single-band antennas. Therefore, it may become necessary to redesign the single-band antenna to achieve a similar performance with different frequencies and/or different types of devices. Contrary to existing antennas there is provided a multi-band patch antenna configured for at least one of transmission or reception of electromagnetic waves in two or more frequency bands with respect to a surrounding environment, the antenna comprising: a conductive antenna element isolated from an electrical ground element of the antenna and configured for operating as a radiating surface for the electromagnetic waves with respect to the surrounding environment, the antenna element having a pair of slots dividing the antenna element into a first parasitic element, a second parasitic element, and a third element such that a first slot of the pair of slots electrically isolates the first parasitic element from the third element and a second slot of the pair of slots electrically isolates the second parasitic element from the third element; the ground element having at least one ground slot; a substrate having a selected dielectric constant and being positioned between the antenna element and the ground element, such that the antenna element is attached to a first surface of the substrate and the ground element is attached to a second surface of the substrate opposite the first surface; a feed point location of the antenna element positioned on the third element, such that only the third element of the antenna element is configured to be coupled to a signal conductor of a transmission line, such that the transmission line is configured to conduct current flow for at least one of towards the antenna element for transmission of the electromagnetic waves from the antenna element or away from the antenna element as a result of reception of the electromagnetic waves by the antenna element; and a feed point location of the ground element configured to be coupled to a ground conductor of the transmission line.

A first aspect provided is a multi-band patch antenna configured for at least one of transmission or reception of electromagnetic waves in two or more frequency bands with respect to a surrounding environment, the antenna comprising: a conductive antenna element isolated from an electrical ground element of the antenna and configured for operating as a radiating surface for the electromagnetic waves with respect to the surrounding environment, the antenna element having a pair of slots dividing the antenna element into a first parasitic element, a second parasitic element, and a third element such that a first slot of the pair of slots electrically isolates the first parasitic element from the third element and a second slot of the pair of slots electrically isolates the second parasitic element from the third element; the ground element having at least one ground slot; a substrate having a selected dielectric constant and being positioned between the antenna element and the ground element, such that the antenna element is attached to a first surface of the substrate and the ground element is attached to a second surface of the substrate opposite the first surface; a feed point location of the antenna element positioned on the third element, such that only the third element of the antenna element is configured to be coupled to a signal conductor of a transmission line, such that the transmission line is configured to conduct current flow for at least one of towards the antenna element for transmission of the electromagnetic waves from the antenna element or away from the antenna element as a result of reception of the electromagnetic waves by the antenna element; and a feed point location of the ground element configured to be coupled to a ground conductor of the transmission line.

A second aspect provided is a multi-band patch antenna configured for at least one of transmission or reception of electromagnetic waves in two or more frequency bands with respect to a surrounding environment, the antenna comprising: a conductive antenna element isolated from an electrical ground element of the antenna and configured for operating as a radiating surface for the electromagnetic waves with respect to the surrounding environment, the antenna element having a pair of slots dividing the antenna element into a first parasitic element, a second parasitic element, and a third element such that a first slot of the pair of slots electrically isolates the first parasitic element from the third element and a second slot of the pair of slots electrically isolates the second parasitic element from the third element; a substrate having a selected dielectric constant and being positioned between the antenna element and the ground element, such that the antenna element is attached to a first surface of the substrate and the ground element is attached to a second surface of the substrate opposite the first surface; a feed point location of the antenna element positioned on the third element, such that only the third element of the antenna element is configured to be coupled to a signal conductor of a transmission line, such that the transmission line is configured to conduct current flow for at least one of towards the antenna element for transmission of the electromagnetic waves from the antenna element or away from the antenna element as a result of reception of the electromagnetic waves by the antenna element; and a feed point location of the ground element configured to be coupled to a ground conductor of the transmission line.

### BRIEF DESCRIPTION OF THE DRAWINGS

These and other features of the invention will become more apparent in the following detailed description in which reference is made to the appended drawings by way of example only, wherein:

FIG. 1 is a diagram of a patch antenna with environment;

FIG. 2 is a first embodiment of the patch antenna of FIG. 1 including a pair of conductors positioned on either side of a substrate;

FIG. 3 is an embodiment of the patch antenna of FIG. 2 in a handheld device;

FIG. 4a is a further embodiment of the ground element of the patch antenna of FIG. 2;

FIG. 4b is a further embodiment of the antenna element of the patch antenna of FIG. 2;

FIG. 5 is another embodiment of the antenna element of FIG. 4b;

FIG. 6a is another embodiment of the ground element of FIG. 4a;

FIG. 6b is another embodiment of the antenna element of FIG. 4b;

FIG. 7 is an example Voltage Standing Wave Ration Graph for the antenna of FIG. 1; and

FIG. 8 is an example radiation pattern for the antenna of FIG. 1.

### DESCRIPTION

### Basic Patch Antenna 10 Characteristics

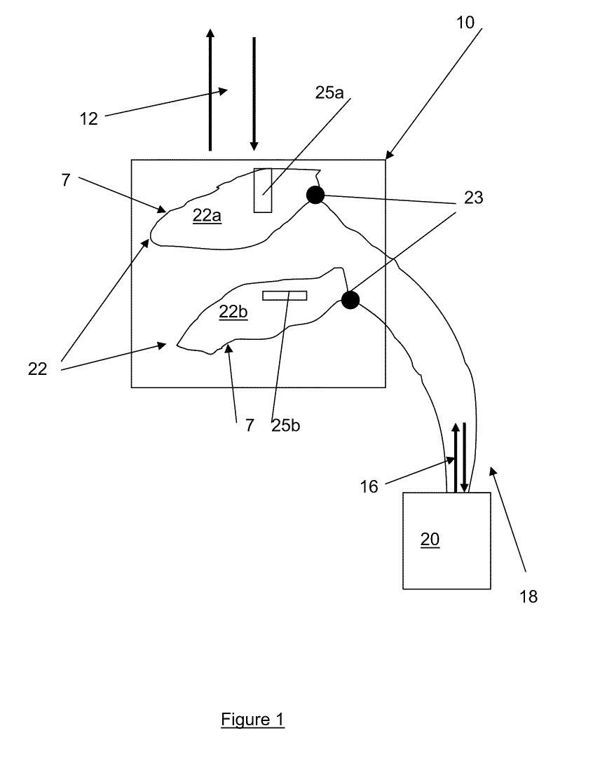

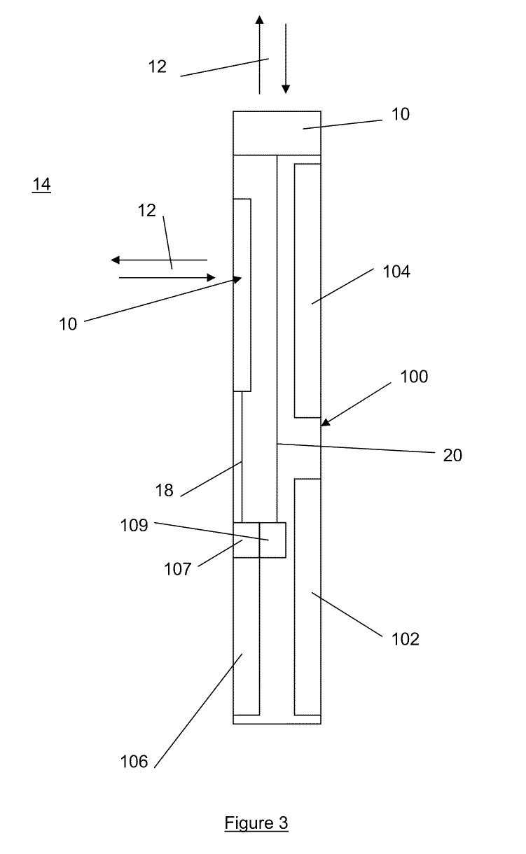

Referring to FIG. 1, a patch antenna 10 is a transducer designed to transmit and/or receive electromagnetic waves 12 from a surrounding environment 14. Accordingly, the patch antenna 10 converts electromagnetic waves 12 into electrical currents 16 (e.g. receive operation) and/or converts electrical currents 16 into electromagnetic waves 12 (e.g. transmit operation), such that the electrical current 16 is communicated via a transmission line/cable/lead 18 coupled between the patch antenna 10 and a current source/sink 20. The wave/current conversion is facilitated by an arrangement of one or more conductors 22 (e.g. metallic elements 22) positioned on an electrically insulating substrate 24. Patch antennas 10 can be used in systems such as radio and television broadcasting, point-to-point radio communication, wireless LAN, radar, product tracking and/or monitoring via Radio-frequency identification (RFID) applications, and space exploration. It is recognised that the patch antenna 10 can be incorporated into or otherwise coupled to a computing device 20, such as for example a portable handheld device (e.g. an RFID reader—see FIG. 3) acting as the current source/sink.

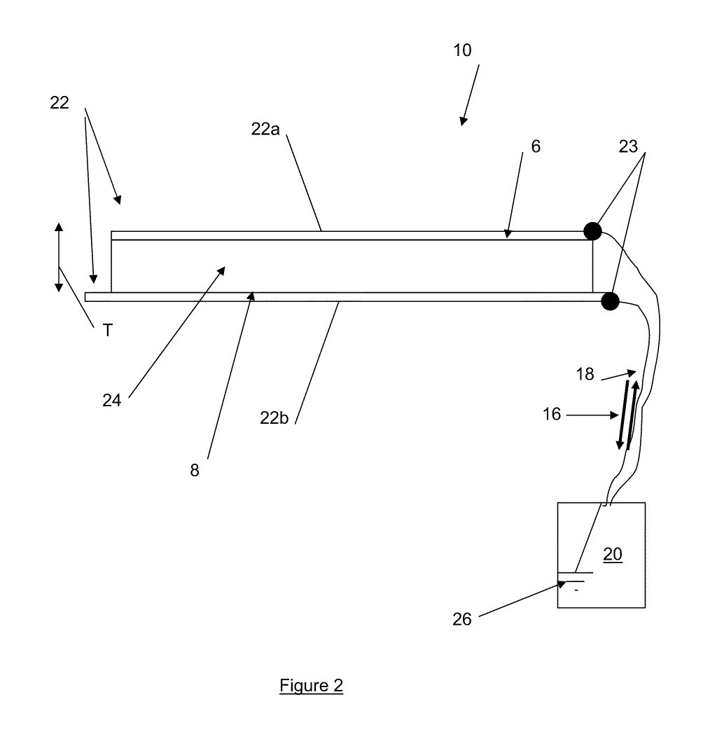

In telecommunication, the patch antenna 10 (e.g. narrowband, wide-beam) is fabricated by positioning the antenna element 22 (i.e. antenna element 22a) in metal trace (e.g. a geometrical shape such as a circle, square, rectangle, ellipse, or other solid/continuous shapes) as bonded (e.g. via adhesive) to the substrate 24 having dielectric properties, with the metal layer 22b (e.g. continuous) bonded to the opposite side 8 of the substrate 24 used as the antenna grounding structure 22b (for establishing a reference potential level for operating the active antenna 10). The antenna grounding structure 22b is closely associated with (or acting as) the ground which is connected to the terminal of the signal receiver or source 20 opposing the active antenna terminal 23. It is recognised in FIGS. 1 and 2 that the illustrated shapes of the elements 22a,22b are by example only, and as such the metallic elements 22a,b can take the form of shapes such as but not limited to planar or non-planar shapes (e.g. square, circular, rectangular, ellipse, etc.). It is recognised that the size and/or shape of the elements 22 can influence the wavelength of the resonance frequency bands of the patch antenna 10. For example, the antenna elements 22a,b can be oversized in terms of the size/area of the dielectric substrate 24, can be the same size as the substrate 24 or could be smaller than the substrate 24.

Physically, the patch antenna 10 can be an arrangement of at least one conductor 22, usually called elements 22 in this context, on one surface 6 of the substrate 24 and at least one conductor 22 on the opposing surface 8 (i.e. spaced apart and opposite to the surface 6) of the substrate 24. The substrate 24 can be used to electrically insulate the one conductor 22 (on the surface 6) from the other conductor 22 (on the surface 8). In transmission, the alternating current 16 is created in the elements 22 by applying a voltage at antenna terminals 23, causing the elements 22 to radiate the electromagnetic field 12. In reception, the inverse occurs such that the electromagnetic field 12 from another source induces the alternating current 16 in the elements 22 and a corresponding voltage at the antenna's terminals 23. Some receiving patch antennas 10 (such as parabolic and horn types) incorporate shaped reflective surfaces to collect EM waves 12 from free space and direct or focus them onto the actual conductive elements 22. Referring to FIG. 1, the patch antenna 10 has a radiating metallic element 22a and a ground plane metallic element 22b, such that each of the elements 22a,b have at least one corresponding slot 25a,b incorporated into the respective element 22a,b.

### Slots 25a,b

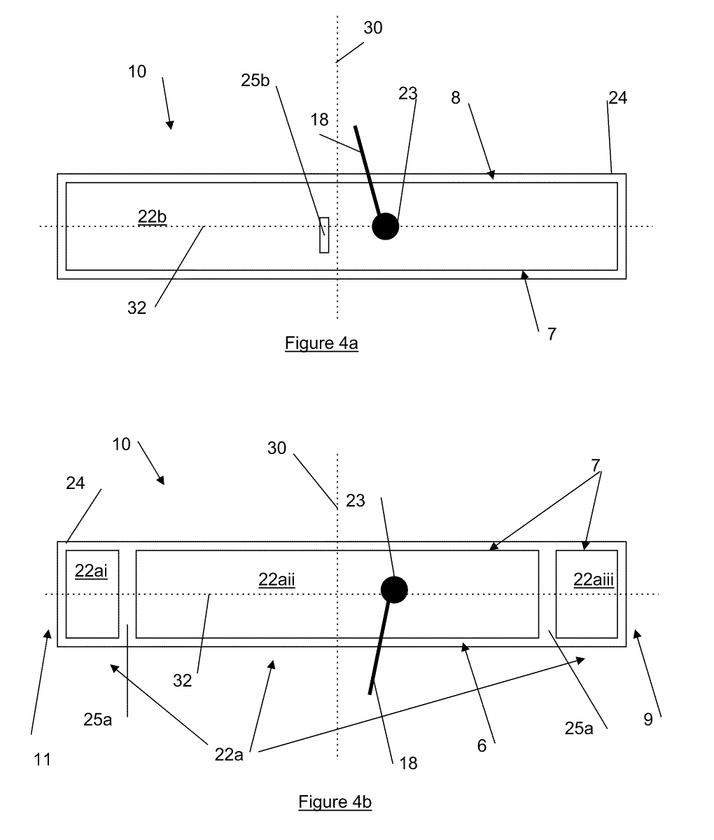

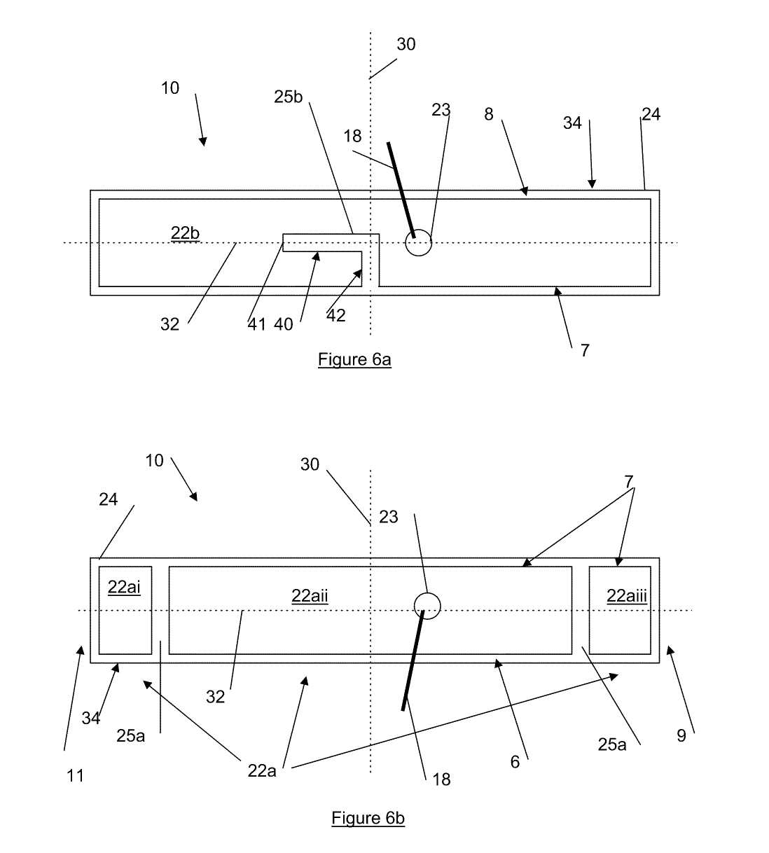

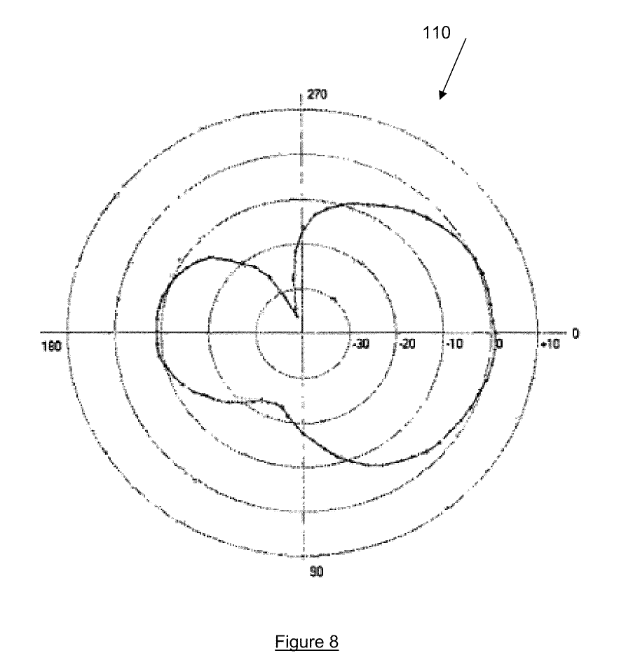

Referring again to FIGS. 1 and 2, the patch antenna 10 consists of the two metal surface elements 22a,b (e.g. flat plates/planes) positioned on opposing surfaces 6,8 of the substrate 24, with the slots 25a,b cut out of the respective elements 22a,b. When the element 22a is driven by a driving current 16 of selected frequency, the slot 25a can radiate electromagnetic waves in similar way to a dipole antenna. It is recognised that the shape and size of the slots 25a,b, as well as the driving frequency, help to determine the radiation distribution pattern 110 (see FIG. 8) of the patch antenna 10. The source slot 25a and ground slot 25b can be created by etching, or otherwise removing, conductive material from the conductive elements 22a,b respectively, in the shape of a line (straight, arcuate, etc.) or other elongated geometrical shape (e.g. rectangle, ellipse, etc.) formed in the conductive material as a groove/channel. Accordingly, the slot 25a,b can be defined as an area on the respective surface 6,8 of the substrate 24 that is non-conductive as compared to the adjacent conductive element 22a,b on the same respective surface 6,8 as that of the slot 25a,b. For example, the slots 25a,b can be positioned internally in the elements 22a,b (e.g. adjacent to but not on or more of the peripheral edges 7 of the element 22a,b) and/or originating from one or more peripheral edges 7 of the elements 22a,b. For example, slot 25a starts from the edge 7 of the element 22a and then extends into the interior region of the element 22a and ends away from the peripheral edge 7. Slot 25b is positioned away from all (i.e. is internal) the peripheral edges 7 of the element 25b. It is also recognised that the slots 25a can both start and finish on the peripheral edges 7, see the antenna 10 of FIGS. 4a, 6b, so as to effectively split the element 22a into two or more adjacent elements.

It is recognized that the slots 25a,b affect the distribution of the current 16 on the elements 22a,b. The relative positioning and sizing of the slots 25a,b on the source element 22a and ground element 22b may be adjusted so as to enhance radiation 12 intensity in a forward direction and/or reduce radiation 12 intensity in a rear direction of the radiation distribution pattern 110. This enhancement/reduction may be accomplished by considering the relative phases of the radiation component from each element 22a,b. Similarly, the spacing between the elements 22a,b may be adjusted to optimize the interaction of the radiation 12 from each element 22a,b to attain the desired radiation pattern 110.

It is recognised that one or more respective slots and/or grooves 25a,b in the exterior surface 6 (facing the environment 14) of the antenna element 22a, and in the exterior surface 8 (facing away from the environment 14) of the antenna element 22b, can be used for tuning of the antenna 10 to desired multiple frequency bands and/or for desired polarization diversities. It is also recognised that these slots and/or grooves 25a,b can also be used to account for non-equal side dimensions of the element 22a (e.g. rectangular and therefore not square), thus making the rectangular shaped antenna element 22a appear to the antenna 10 as square shaped and thus compatible with circular polarized diversity tuning for the antenna 10, for example.

Antenna element 22a

The antenna element 22a operates as radiating surface for impinging electromagnetic radiation 12 coming from or going to the active antenna 10. For example, the antenna element 22a is not connected to the ground 26, as compared to the provided configuration of ground element 22b. Instead, the antenna element 22a can be electrically insulated from the ground element 22b that is coupled to ground 26. The patch antenna 10 consists of the metal patch 22a suspended over the ground patch 22b. A simple patch antenna 10 uses a patch 22a which is one half-wavelength-long with the dielectric loading included over a larger ground plane 22b separated by a constant thickness dielectric substrate 24. For example, a simple single band patch antenna for 2.4 GHz would have a simple patch 22a of approximately 62.5 mm long as compared to a simple single band patch antenna for 5 GHz would have a simple patch 22a of approximately 30 mm long, as compared to the dimensions of the patch 22a for the multiband patch antenna 10 (see FIGS. 6a,b) further discussed below.

It is recognised that electrically large ground planes 22b can produce stable patterns 12 and lower environmental. For example, the ground plane 22b can be the same size or only modestly larger than the active patch 22a. It is recognised that when a ground plane 22b is close to the size of the radiator element 22a, the ground plane 22b can couple and produce currents 16 along the edges of the ground plane 22b which also can contribute to the radiation 12. In this case, the antenna radiation 12 pattern becomes the combination of the two sets of radiators.

The ground plane 22b can cut off most or all radiation 12 behind the antenna 10, thereby reducing the power averaged over all directions by a factor and thus increasing the gain. The impedance bandwidth of the patch antenna 10 is influenced by the spacing (thickness T) between the patch 22a and the ground plane 22b. As the patch 22a is moved closer to the ground plane 22b, less energy is radiated and more energy is stored in the patch capacitance and inductance: that is, the quality factor Q of the antenna 10 increases.

### Grounding Element 22b

An example of the grounding structure 22b is a ground plane 22b as a metal layer bonded to the underside surface 8—in opposite to the antenna element 22a—of the substrate 24, and connected to the ground 26 itself (i.e. one of the conductors of the transmission line 18 is connected between the ground element 22b and the ground 26 of the device 20 (e.g. an electrical ground of a handheld terminal 20 that is coupled to the antenna 10 via the transmission line 18).

The antenna grounding element 22b can be referred to as a structure for establishing a reference potential level for operating the active antenna element 22a. The antenna grounding element 22b can be any structure closely associated with (or acting as) the ground 26 which is connected to the terminal 23 of the signal receiver or source opposing the active antenna terminal 23. In telecommunication, a ground plane element 22b or relationship exists between the antenna 22a and another object, where the only structure of the object is a structure which permits the antenna 22a to function as such (e.g., forms a reflector or director for an antenna). This sometimes serves as the near-field reflection point for an antenna 10, or as a reference ground in a circuit. A ground element 22b can also be a specially designed artificial surface (such as the radial elements of a quarter-wave ground plane antenna 10). Artificial (or substitute) grounds (e.g., ground planes 22b) concern the grounding structure for the antenna 10 and includes the conductive structure used in place of the earth and which grounding structure is distinct from the earth. For example, a ground plane 22b in the antenna 10 assembly is a layer 22b of copper that appears to most signals 12 as an infinite ground potential. The use of the ground plane 22b can help reduce noise and help provide that all integrated circuits within a system (e.g. handheld 20) compare different signals' voltages to the same potential. The ground plane 22b also serves to facilitate directional radiation pattern 100 tuning.

It is also recognised that the ground plane 22b can sometimes be split and then connected by a thin trace. The thin trace can have low enough impedance to keep the connected sides (portions) of the ground plane 22b very close to the same potential while keeping the ground currents of one side/portion from significantly impacting the other, as provided by one or more respective transmission lines 18.

### Transmission Line/Cable 18

As shown in FIG. 2, the transmission (e.g. feed) line 18 in a radio transmission, reception or transceiver system is the physical cabling 18 that carries the RF signal 16 to and/or from the antenna 10. The feed line 18 carries the RF energy for transmission and/or as received with respect to the antenna 10. There are different types of feed lines 18 in use in modern wireless antenna 10 systems, lines 18 such as but not limited to: the coaxial type, the twin-lead, and, at frequencies above 1 GHz, a waveguide. For example, the coaxial cable 18 is a rounded cable with a center conductor and a braided or solid metallic shield, usually copper or aluminum. The center conductor is separated from the outer shield by an insulator material, such that the center conductor is connected to the antenna element 22a and the braided/solid metallic shield is connected to the ground plane 22b and/or the ground 26, such that the antenna element 22a is separated electrically by the substrate 24.

The current flow in the elements 22a,b is along the direction of the feed line 18, so the magnetic vector potential and thus the electric field follow the current flow. The radiation 12 can be regarded as being produced by the “radiating slots” at top and bottom, or equivalently as a result of the current flowing on the patch 22a and the ground plane 22b.

### Substrate 24

The dielectric loading of the patch antenna 10 affects both its radiation pattern and impedance bandwidth. As the dielectric constant of the substrate 24 increases, the patch antenna 10 bandwidth decreases which increases the Q factor of the patch antenna 10 and therefore decreases the impedance bandwidth. The radiation from a rectangular patch antenna 10 has the highest directivity when the antenna 10 has an air dielectric and decreases as the antenna is loaded by substrate 24 material with increasing relative dielectric constant. It is recognised that the dielectric property of the substrate 24 (providing a dielectric resonator property) provides for an electrically insulating material positioned between the metallic elements 22 (e.g. plates) of the patch antenna 10. A good dielectric typically contains polar molecules that reorient in external electric field, such that this dielectric polarization can increases the antenna's 10 capacitance.

Certain desirable properties such as increased efficiency may be obtained by using a material for substrate 24 that has specific properties, such as a particular permittivity or dielectric constant, at the desired frequency or frequency range of operation. For example, at higher multiband frequencies, such as frequencies of 2.4 and 5 GHz, a higher dielectric constant may be desirable. Preferably, the material used for substrate 24 has uniform thickness and properties.

Generalizing this, any insulating substance can be called a dielectric. While the term “insulator” refers to a low degree of electrical conduction, the term dielectric is typically used to describe materials with a measured high polarization density. The relative static permittivity (or static relative permittivity) of a material under given conditions is a measure of the extent to which it concentrates electrostatic lines of flux. It is the ratio of the amount of stored electrical energy when a potential is applied, relative to the permittivity of a vacuum. The relative static permittivity is the same as the relative permittivity evaluated for a frequency of zero. Other terms for the relative static permittivity are the dielectric constant, or relative dielectric constant, or static dielectric constant. It is recognised that relative permittivity of the dielectric material of the layers 24a,b,c can refer to a relative permittivity as either static or frequency-dependent relative permittivity depending on context. The relative static permittivity, ∈r, can be measured for static electric fields as follows: first the capacitance of a test capacitor, C0, is measured with vacuum between its plates. Then, using the same capacitor and distance between its plates the capacitance Cx with a dielectric between the plates is measured. The relative dielectric constant can be then calculated as ∈r=Cx/C0. For time-variant electromagnetic fields 12, this quantity becomes frequency dependent and in general is called relative permittivity.

A dielectric resonator property can be defined as an electronic component that exhibits resonance for a selected narrow range of frequencies, generally in the microwave band. The resonance of the substrate 24 can be similar to that of a circular hollow metallic waveguide, except that the boundary is defined by large change in permittivity rather than by a conductor. Dielectric resonator property of the substrate 24 is provided by a specified thickness T of dielectric material having a specified dielectric constant and a low dissipation factor. The resonance frequency of the substrate 24 is determined by the overall physical dimensions of the substrate 24 and the dielectric constant of the substrate material. It is recognised that dielectric resonators can be used to provide a frequency reference in an oscillator circuit, such that an unshielded dielectric resonator is used in the antenna 10 to facilitate radiation 12.

As noted above, the conducting layers 22a,b of the patch antenna 10 can be made of thin copper foil. The substrate/carrier 24 is composed of an insulating layer dielectric, e.g. laminated together with epoxy resin. There are a number of different dielectric materials that can be chosen to provide different insulating values for the carrier 24 depending on the requirements of the antenna elements 22a,b. Some of these dielectric materials are, for example, polytetrafluoroethylene (Teflon), FR-1, FR-2 (Phenolic cotton paper), FR-3 (Cotton paper and epoxy), FR-4 (Woven glass and epoxy), FR-5 (Woven glass and epoxy), FR-6 (Matte glass and polyester), G-10 (Woven glass and epoxy), CEM-1 (Cotton paper and epoxy), CEM-2 (Cotton paper and epoxy), CEM-3 (Woven glass and epoxy), CEM-4 (Woven glass and epoxy), CEM-5 (Woven glass and polyester). Another example of the dielectric material of the substrate is Taconic RF laminates such as CER-10 RF & Microwave Laminate. The CER-10 material has a dielectric Constant@ 10 GHz of 10 based on a test method of IPC TM 650 2.5.5.6.

Further, the substrate 24 may be another non-conductive material such as a silicon wafer or a rigid or flexible plastic material. The substrate 24 may also be formed into a non-flat shape e.g., curved, so has to fit into a specific space within, for example, a device housing 100 (see FIG. 3).

### RF Radiation 12

Radio frequency (RF) radiation 12 of the antenna 10 is a subset of electromagnetic radiation 12 with a wavelength of 100 km to 1 mm, which is a frequency of 300 Hz to 3000 GHz, respectively. This range of electromagnetic radiation 12 constitutes the radio spectrum and corresponds to the frequency of alternating current electrical signals 16 used to produce and detect radio waves 12 in the environment 14. Ultra high frequency (UHF) designates a range of electromagnetic waves 12 with frequencies between 300 MHz and 3 GHz (3,000 MHz), also known as the decimetre band or decimetre wave as the wavelengths range from one to ten decimetres (10 cm to 1 metre). For example, RF can refer to electromagnetic oscillations in either electrical circuits or radiation through air and space. Like other subsets of electromagnetic radiation, RF travels at the speed of light. It is also recognised that the radio waves 12 can be detected and/or generated by the antenna 10 in frequency ranges other than in the UHF band, such as but not limited to a plurality of frequency sub-bands (e.g. dual/multi-band 3G/4G applications such as UMTS or CDMA or WiMAX or WiFi in which there are multiple so-called frequency bands—for example 700/850/900 MHz and 1800/1900/2100 MHz within two major low and high wavelength super bands). Further, the patch antenna 10 can be configured as a multi-band antenna 10 for operation in two or more defined bands of the IEEE 802.11 set of standards for carrying out wireless local area network (WLAN) computer communication (e.g. 2.4, 3.6 and 5 GHz frequency bands), such as but not limited to 802.11a, 802.11b, 802.11g, and/or 802.11n.

For example, the 802.11 standard divides each of the above-described bands into channels, with various channel width and overlap. For example the 2.4000-2.4835 GHz band is divided into 13 channels each of width 22 MHz but spaced only 5 MHz apart, with channel 1 having a center frequency of 2.412 GHz and channel 13 having a center frequency of 2.472 GHz.

From a standard point of view, the multiband patch antenna 10 can be a “dual band” working on: 802.11b as a first band in the 2.4-2.5 GHz range and 802.11a as a second band in the 5.15-5.88 GHz range. From a frequency range point of view, the multi-band patch antenna 10 can accommodate tow or more bands (e.g. up to 4 bands) with different limits based on different countries, e.g. a first band in 2.40-2.50 GHz, a second band in the 5.15-5.25 GHz, a third band in the 5.25-5.35 GHz, and a fourth band in the 5.725-5.835 GHz. In any event, it is recognised that each of the bands have distinct center frequencies in the radio spectrum 12.

Accordingly, it is recognised that the antenna 10 described herein is not limited to UHF RFID applications and could readily be applied to any radio communication technology at UHF frequencies or higher frequencies (e.g. WAN, WIFI, Bluetooth, GPS and/or other), wherein particular advantages of the patch antenna 10 of multi-band capability may be appreciated.

### Patch Antenna 10 Properties

Patch antennas 10 can be most commonly employed in air or outer space environment 14, but the patch antennas 10 can also be operated in under water or even through soil and rock environments 14 at certain frequencies for specified distances. It is recognised that the words antenna and aerial can be used interchangeably; but typically a rigid metallic structure is termed an antenna and a wire format is called an aerial.

There are two fundamental types of antenna 10 directional patterns, which, with reference to a specific two dimensional plane (usually horizontal [parallel to the ground] or vertical [perpendicular to the ground]), are either: omni-directional (radiates equally in all directions), such as a vertical rod (in the horizontal plane); or directional (radiates more in one direction than in the other). For example, omni-directional can refer to all horizontal directions with reception above and below the antenna 10 being reduced in favour of better reception (and thus range) near the horizon. A directional antenna 10 can refer to one focusing a narrow beam in a specified specific direction or directions. By adding additional elements (such as rods, loops or plates) and arranging their length, spacing, and orientation, an antenna 10 with desired directional properties can be created. An antenna 10 array can be defined as two or more simple antennas 10 combined to produce a specific directional radiation 12 pattern, such that the array is composed of active elements 22.

The gain as an antenna parameter measures the efficiency of a given patch antenna 10 with respect to a given norm, usually achieved by modification of its directionality. A patch antenna 10 with a low gain emits radiation 12 with about the same power in all directions, whereas a high-gain patch antenna 10 will preferentially radiate 12 in particular directions. Specifically, the gain, directive gain or power gain of the patch antenna 10 can be defined as the ratio of the intensity (power per unit surface) radiated 12 by the antenna 10 in a given direction at an arbitrary distance divided by the intensity radiated 12 at the same distance by a hypothetical isotropic antenna 10.

### Device 20

Referring to FIG. 3, the handheld terminal 20 can have the patch antenna 10 coupled via a feed line 18 to a battery 106 and a transceiver 107 (for example as a transmitter only for transmitting, a receiver only for receiving or combined as the transceiver for both transmission and reception of the waves 12) and housed (i.e. coupled/mounted) at least partially in the interior of a main housing 100 of the handheld 20 (e.g. on the backside of the housing opposite a display 104 and/or a keyboard 102). Another configuration example is in the end of the housing 100 of the handheld 20 adjacent to the display 104 and/or the keypad 102, coupled to the battery 106 via a transceiver 109 (for example as a transmitter only for transmitting, a receiver only for receiving or combined as the transceiver for both transmission and reception of the waves 12). It is recognised that the patch antenna 10 can be configured to operate as a communication antenna for WAN, WIFI, Bluetooth, GPS or as an RFID antenna. It is also recognized that the handheld 20 can be embodied as a generic mobile device such as a mobile communication device, the handheld as described, or a body-worn personal communication device.

### Patch Antenna 10

In any event, referring to FIGS. 4a,b, it is recognised that the patch antenna 10 can comprise: an antenna element 22a configured to be isolated from the electrical ground element 22b of the antenna 10; a feed/transmission line 18 having a pair of electrical conductors such that a first conductor of the pair of electrical conductors is connected to the antenna element 22a at the feed point 23 (of the surface 6) and a second conductor of the pair of electrical conductors is connected at the feed point 23 (of the surface 8) to the electrical element 22b; and a substrate 24 having a selected relative static permittivity, such that the substrate 24 is positioned between the antenna element 22a and the electrical element 22b. The antenna element 22a is attached to the first surface 6 of the substrate 24 and the ground element 22b is attached to the second surface 8 of the substrate 24 that is opposite to the first surface 6. Further, it is noted that the ground lead of the transmission line 18 is connected (at point 23) directly to the metallic ground element 22b and the active lead of the transmission line 18 is connected (at point 23) directly to the metallic antenna element 22a.

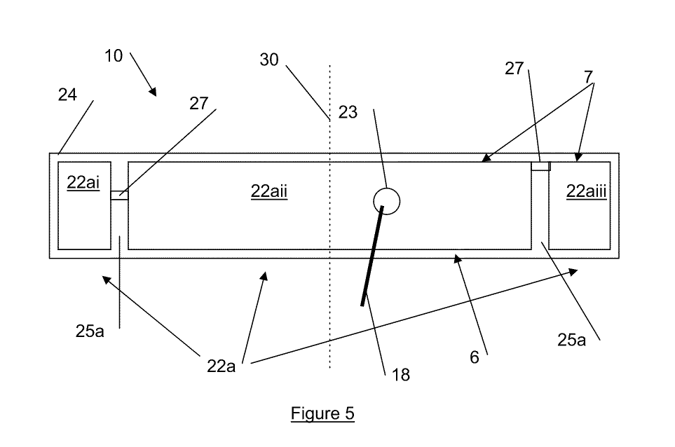

Further, it is recognised that the feed point 23 on either surface 6,8 can be located either on or off a central (equidistant between the ends 9,11) transverse axis 30 of the patch antenna 10. Also, referring to FIG. 4b, the antenna element 22a has two slots 25a that separate (i.e. the slots 25a start and finish on the peripheral edge 7 of the antenna element 22a) the antenna element 22a into a first parasitic element 22ai, a second parasitic element 22aiii, and a between element 22aii (e.g. between the first and second parasitic elements 22ai, 22aiii). The between element 22aii is the only antenna element 22a that has the feed point 23 on the surface 6, such that the parasitic elements 22ai, 22aiii are electrically separated by the slots 25a from the current 16 delivered/received (of the feed line 18) via the feed point 23. The ground element 22b also has a slot 25b positioned on the surface 8 away from the feed point 23. The slot 25b can be straight, L shaped, F shaped, or other slot shapes as desired, as well as being internal to the ground element 22b and/or starting on the peripheral edge 7. Also, the slots 25a can be straight and/or other slot shapes as desired, as long as the slots 25a start and finish on the peripheral edges 7 so as to electrically isolate the parasitic elements 22ai, 22aiii from the between element 22aii, such that the slots 25a can be located the same distance (or different distances) from their respective ends 9,11 of the substrate 24 measured along the longitudinal axis 32. It is also envisioned that the elements 22ai, 22aiii can be connected to the between element 22aii by one or more metallic traces 27 (see FIG. 5), as desired, such that one or more of the slots 25a may not both start and end on the peripheral edges 7.

Accordingly, the patch antenna 10 includes the substrate 24 having a pair of oppositely directed surfaces 6,8. A source plane conductor 22a is located on one of the surfaces 6 and has the signal line 18 connected thereto. A ground plane conductor 22b is located on another of the surfaces 8. Each of the conductors 22a,b has at least one slot 25a,b extending there-through with the slots 25a,b sized and positioned relative to one another to inhibit the intensity of radiation emanating from the ground plane 22b for use in tuning the patch antenna 10 to operate as a multi-and antenna 10. In a particular embodiment, the substrate 24 may be, for example, the substrate portion of a printed circuit board (PCB). The conductive planes 22a,b can be created by covering the substrate 24, through lamination, roller-cladding or any other such process, with a layer of a conductive material, for example copper. The source slots 25a and ground slot 25b can be created by etching, or otherwise removing, conductive material from the conductive planes 22a,b respectively. For example, the ground slot 25b can be L shaped with one leg extending parallel to a longitudinal axis 32 of the antenna 10 and the other leg extending normal or transverse to the axis 32 (i.e. parallel to the avis 30). A signal line 18 connected to the source plane 22a at point 23 of the surface 6 and the ground plane 22b is connected to the ground line 18 at point 23 of the surface 8, e.g. by a cable shield of the line 18. For example, the feed point can be a hole in the substrate 24 sized to fit the line 18 there-through, such that the signal feed line 18 is connected to the antenna element 22aii adjacent to the feed point hole 23 while the ground feed line 18 (e.g. metal shielding) is connected to the ground element 22b adjacent to the feed point hole 23.

### Specific Antenna Example Configuration

Referring to FIGS. 6a,b, shown is an embodiment of the patch antenna 10, where the antenna element 22a includes one antenna element 22aii connected to the signal line 18 at feed point 23 and a plurality of parasitic antenna elements 22ai, 22aiii using the slots 25a to separate the resonate antenna element 22a to form the parasitic antenna elements 22ai, 22aiii (i.e. the parasitic elements 22ai, 22aiii are electrically isolated by the slots 25a from the current 16 associated with the line 18 connected to the feed point 23 on the between element 22aii). It is recognised that the use of the antenna element 22aii and parasitic elements 22ai, 22aiii contribute to the multi-band resonance capability of the patch antenna 10. For example, the first frequency band can be approximately 2.4 to 2.5 GHz and the second frequency band can be approximately 5.15 to 5.85 GHz. Other multiple RF bands configurations can be implemented as well. It is recognised that the antenna element 22a can be directly coupled to the transceiver unit with or without an intervening multiplexing functionality or circuitry (not shown).

Accordingly, it is recognised that the antenna 10 provides transmission or reception of two or more radio frequency signals 12 using a single (i.e. only on the third element 22aii and not on either of the parasitic elements 22ai, 22aiii) feed point 23 designed to work for the multiple specific radio frequency bands of interest. The transmission line 18 is configured to conduct current flow 16 for at least one of towards the antenna element 22aii for transmission of the electromagnetic waves 12 from the antenna element 22a or away from the antenna element 22aii as a result of reception of the electromagnetic waves 12 by the antenna element 22a.

In terms of example dimensions, the antenna element 22a can have a distance of approximately 0.25 mm from the edges 34 of the substrate 24 (i.e. the surface area of the elements 22a,b is less than the corresponding surface area of the substrate 24—even ignoring the contribution of the reduction in element 22a,b area due to the slots 25a,b and feed hole 23). The substrate 24 can be 47 mm long and 4 mm wide (making the ground element 22b approximately 3.5 mm wide and 46.5 mm long). The parasitic element 22ai begins approximately 5.3 mm (i.e. approximately 5.05 mm long) from the end 11 of the substrate 24 and the parasitic element 22aiii begins approximately 7.9 mm (i.e. approximately 7.65 mm long) from the end 9 of the substrate 24, as measured along the axis 32. Accordingly, the elements 22ai, 22aiii have different surface areas for their respective metal layers located at opposite ends 9,11 of the substrate 24 along the axis 32. The width of the slots 25a (measured along the axis 32) is approximately 1 mm (e.g. 40 mils) each. It is recognised that the slots 22ai, 22aiii can be of different widths, as desired.

In terms of the between element 22aii, the length along the axis 32 is approximately 31.8 mm. The antenna element 22aii has a surface area greater than either of the parasitic elements 22ai, 22aiii. It is recognised that the antenna element 22aii can comprise a major portion of surface area of the antenna element 22a(e.g. having a surface area greater than the combined surface area of the parasitic elements 22ai, 22aiii). The feed point 23 on the between element 22aii can be located adjacent to the transverse axis 30, e.g. a measured distance from the axis 30. The feed point 23 on the between element 22aii can be located on the longitudinal axis 32. The feed point 23 on the between element 22aii can be located adjacent to the longitudinal axis 32, e.g. a measured distance from the axis 32.

In terms of the ground element 22b, for the ground slot 25b, an axial leg 40 is 3.4 mm long and its distal end 41 is approximately 22 mm from the end 11 of the substrate 24, and a transverse leg 42 is 1.5 mm long starting on the edge 7 of the ground element 7, for example. The width of the slot 25b is approximately 0.5 mm (e.g. 20 mils). Accordingly, the width of the ground slot 25b is less than the width of the antenna slots 25a, for example. Further, it is recognised that the transverse position of the axial leg 40 can be symmetrical about the longitudinal axis (i.e. the width of the leg 40 is equal on either side of the longitudinal axis 30), for example. It is also recognised that the transverse leg 42 can be located adjacent to or on the transverse axis 30, as desired. For example, the transverse axis 30 can be positioned between the transverse leg 42 and the feed point 23 of the ground element 22b. Further, the feed point 23 of the ground element 22b can be located on the longitudinal axis 32, between the longitudinal axis 32 and the edge 7 of the ground element 22b (i.e. to one side of the longitudinal axis 32), or on the edge 7 of the ground element 22b.

Further, the elements 22a,b can be of 0.030 inch thickness, and the substrate 24 thickness can be 8-15 or 30-60 micro inches, for example.

It is also recognised that mounting holes (not shown) can be formed in the through the substrate and respective elements 22a,b to provide for attachment of the patch antenna 10 to the housing 100 of the device 20 (see FIG. 3). For example, the mounting holes can be located at either end 9,11 of the antenna 10 of approximately 1.6 mm diameter. Otherwise, or in addition to, the substrate 24 can have extension members (not shown) for use in coupling the antenna 10 to the housing 100. In view of the above-presented dimensions, it is recognised that these dimensions are approximate and can vary by plus or minus 0.1 to 0.3 mm, for example.

It is also recognised that a lower-frequency band (e.g. 2.4 Ghz) of the multi-band antenna 10 can be adjusted by changing the dimensions, shape and/or positioning of the slots 25a,b and an upper-frequency band (e.g. 5 GHz) can be adjusted by the overall dimensional size and/or shape of the elements 22a,22b.

### Patch Antenna 10 Example Operational Characteristics

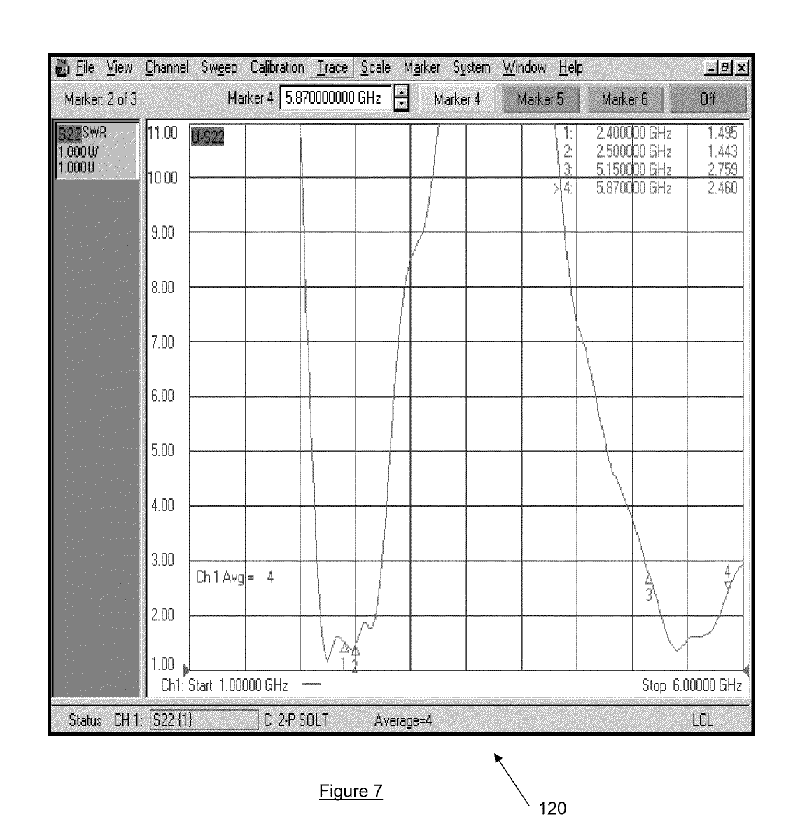

Referring to FIG. 7, the Voltage Standing Wave Ratio (VSWR) graph measurements 120 for the example multiple frequency band range. It is recognised that an internal antenna 10 is desired to have VSWR measurements below 3 or between 1 and 3. For example, the VSWR value of 1 is considered ideal and it will be “equivalent” with a wired connection (i.e. all of the energy 12 sent through the feed line 19 to the antenna 10 will be transmitted out towards the receiving antenna). In the real life some energy will be lost even through a pair of wires of the feed lines 18 of the antennas 10. Looking at the attached VSWR measurements 120, we can see that for the frequency range corresponding to 802.11b (2.4 to 2.5 GHz) the measurements are less than 1.5 (1.495 for Marker 1 and 1.443 for Marker 2 on the upper right side of the graph). For the 802.11a frequency range, the VSWR measurements 120 are less than 3 (e.g. 2.759 and 2.46) for all of the frequency 3 bands.

### Radiation Pattern 110

Referring to FIG. 8, the antenna 10 can exhibit the radiation pattern 110 that tends to be directional, which shows a graph of the radiation pattern for such an antenna 10. It may be observed that the radiation pattern of such an antenna 10 tends to be null along the axis of the antenna 10 and of reduced power when emanating from the ground plane 22b (see FIG. 2) when compared to the source plane 22a. Therefore, it may be desirable to configure a particular application of such an antenna 10 according to an appropriate orientation with respect to a receiver to which the antenna 10 is expected to radiate 12 (or, a transmitter from which the antenna 10 is expected to receive a signal 12). Further, it is recognised that the use of such an antenna 10 may reduce or avoid blockage of the radiated signal by, for example, the user's head or hand, in an application such as a cellular telephone, a PDA, a handheld scanner 20 or any other handheld wireless device 20. A possible benefit is the reduction in measured specific absorption rate (SAR), which is related to the heating of body tissues caused by the radio waves 12 outputted by the wireless device 20. Another possible benefit is that the ground plane 22b also serves to reduce or block high frequency noise generated by processors used within the wireless device 20, which clock frequencies may fall within the frequency bands of the antenna 10.

It is also recognised that the relative positioning and sizing of the slots 25a,b on the source plane 22a and ground plane 22b may be adjusted so as to enhance the radiation intensity pattern 110 in the forward direction (towards the environment 14—see FIG. 1) and reduce the radiation intensity pattern 110 in the rear direction (away from the environment 14—see FIG. 1). This may be accomplished by considering the relative phases of the radiation 12 component from each plane 22a,b. Similarly, the spacing between the planes 22a,b may be adjusted to optimize the interaction of the radiation 12 from each plane 22a,b to attain the desired radiation pattern 110.

I claim:

1. A multi-band patch antenna configured for at least one of transmission or reception of electromagnetic waves in two or more frequency bands with respect to a surrounding environment, the antenna comprising:
a conductive antenna element isolated from an electrical ground element of the antenna and configured for operating as a radiating surface for the electromagnetic waves with respect to the surrounding environment, the antenna element having a pair of slots dividing the antenna element into a first parasitic element, a second parasitic element, and a third element such that a first slot of the pair of slots electrically isolates the first parasitic element from the third element and a second slot of the pair of slots electrically isolates the second parasitic element from the third element;
the ground element having at least one ground slot;
a substrate having a selected dielectric constant and being positioned between the antenna element and the ground element, such that the antenna element is attached to a first surface of the substrate and the ground element is attached to a second surface of the substrate opposite the first surface;
a feed point location of the antenna element positioned on the third element, such that only the third element of the antenna element is configured to be coupled to a signal conductor of a transmission line, such that the transmission line is configured to conduct current flow for at least one of towards the antenna element for transmission of the electromagnetic waves from the antenna element or away from the antenna element as a result of reception of the electromagnetic waves by the antenna element; and
a feed point location of the ground element configured to be coupled to a ground conductor of the transmission line.

2. The patch antenna of claim 1, wherein the third element is between the parasitic elements along a longitudinal axis of the antenna.

3. The patch antenna of claim 2, wherein a surface area of the first parasitic element is less than a surface area of the second parasitic element.

4. The patch antenna of claim 3, wherein the feed point location of the third element is closer to the second parasitic element.

5. The patch antenna of claim 2, wherein the ground slot is an L shaped slot.

6. The patch antenna of claim 5 further comprising a longitudinal leg of the ground slot positioned along the longitudinal axis of the antenna.

7. The patch antenna of claim 7 further comprising a transverse leg of the ground slot connecting the longitudinal leg to a peripheral edge of the ground element.

8. The patch antenna of claim 5, wherein the feed point location of the ground element is positioned adjacent to the ground slot on the longitudinal axis.

9. The patch antenna of claim 8, wherein the feed point location of the third element is closer to the second parasitic element and the feed point locations are aligned with respect to one another through the thickness of the substrate.

10. The patch antenna of claim 2, wherein a width of the ground slot is less that a width of the first slot or the second slot.

11. The patch antenna of claim 2, wherein a peripheral edge for the perimeter of the antenna element is positioned directly opposite to a peripheral edge for the perimeter of the ground element.

12. The patch antenna of claim 2 wherein the antenna is configured as a multi-band antenna 10 for operation in two or more defined bands of the IEEE 802.11 set of standards selected from the group consisting of: 802.11a; 802.11b; 802.11g; and 802.11n.

13. The patch antenna of claim 12, wherein a center frequency of a first band of the two or more defined bands is outside of the frequency band of a second band of the two or more defined bands.

14. The patch antenna of claim 12, wherein the antenna has a 2.4-2.5 GHz range first band and a 5.15-5.88 GHz range second band.

15. The patch antenna of claim 12, wherein the antenna has a first band in a 2.40-2.50 GHz range, a second band in a 5.15-5.25 GHz range, a third band in a 5.25-5.35 GHz range, and a fourth band in a 5.725-5.835 GHz range.

16. The patch antenna of claim 2, wherein the antenna element and the ground element are positioned on the substrate being planar.

17. The patch antenna of claim 16, wherein the antenna element is a metallic patch as a two dimensional metallic sheet.

18. The patch antenna of claim 17, wherein the metallic sheet is a rectangular shape.

19. The patch antenna of claim 16, wherein the ground element is a metallic patch as a two dimensional metallic sheet.

20. The patch antenna of claim 19, wherein the metallic sheet is a rectangular shape.

21. A multi-band patch antenna configured for at least one of transmission or reception of electromagnetic waves in two or more frequency bands with respect to a surrounding environment, the antenna comprising:
a conductive antenna element isolated from an electrical ground element of the antenna and configured for operating as a radiating surface for the electromagnetic waves with respect to the surrounding environment, the antenna element having a pair of slots dividing the antenna element into a first parasitic element, a second parasitic element, and a third element such that a first slot of the pair of slots electrically isolates the first parasitic element from the third element and a second slot of the pair of slots electrically isolates the second parasitic element from the third element;
a substrate having a selected dielectric constant and being positioned between the antenna element and the ground element, such that the antenna element is attached to a first surface of the substrate and the ground element is attached to a second surface of the substrate opposite the first surface;
a feed point location of the antenna element positioned on the third element, such that only the third element of the antenna element is configured to be coupled to a signal conductor of a transmission line, such that the transmission line is configured to conduct current flow for at least one of towards the antenna element for transmission of the electromagnetic waves from the antenna element or away from the antenna element as a result of reception of the electromagnetic waves by the antenna element; and
a feed point location of the ground element configured to be coupled to a ground conductor of the transmission line.
